(19) United States
(12) Patent Application Publication
(10) Pub. No.: US 2020/0349375 A1
(43) Pub. Date: Nov. 5, 2020

(54) Sensing Apparatus and Method

(71) Applicant: University Court of the University of St Andrews, St Andrews (GB)

(72) Inventors: Aaron Quigley, St Andrews (GB); Hui Shyong Yeo, St Andrews (GB); David Harris-Birtill, St Andrews (GB)

(21) Appl. No.: 16/643,141

(22) PCT Filed: Aug. 31, 2018
(86) PCT No.: PCT/GB2018/052462

§ 371 Date: Feb. 28, 2020

(30) Foreign Application Priority Data
Sep. 1, 2017 (GB) 1714067.4

(51) Int. Cl. G06K 9/20; G06K 9/00; G06K 9/46; G06K 9/62; G06T 7/40; H04M 1/725; G01J 3/50; G01J 3/02

(52) U.S. Cl. CPC G06K 9/2018; G06K 9/00664; G06K 9/4661; G06K 9/6256; H04M 2250/52; G06T 7/40; H04M 1/72569; G01J 3/506; G01J 3/0208; G06K 9/4652

(57) ABSTRACT

A method comprises positioning a display screen of a mobile device and a surface of interest such that the display screen of the mobile device faces the surface of interest; emitting light by the display screen, wherein at least part of the emitted light is reflected by the surface of interest; receiving, by a camera of the mobile device, at least part of the light emitted by the display screen and reflected from the surface of interest thereby to generate at least one image; and processing the at least one image to determine at least one property of the surface of interest.

### FIELD

The present apparatus relates to a sensing apparatus and method, for example an apparatus and method for sensing different surface colours and materials using a multi-spectral light source in combination with a camera.

### BACKGROUND

Today, mobile computing may readily afford us an opportunity to determine our approximate location and to use this information to customize our interactions. From navigation to gaming, or location based reminders to recommendation engines, location based services may be considered ubiquitous with GPS, assisted-GPS or hybrid approaches to sensing [12, 13].

However, fine-grained location information within an environment may often rely on new mobile hardware or sensing infrastructures. As a result, less attention has been paid to determining a mobile device's exact location, such as if the device is placed on a desk, in a pocket, or on any arbitrary surface.

In understanding where a mobile device is, prior work has attempted to determine the location of devices using a variety of sensing methods including light, sound, vibrations, radio-waves and images captured through micro-cameras. However, most of these methods rely on external hardware support and do not use off-the-shelf devices.

Moreover, although early work has showcased that it may be possible to estimate the location of a device by determining the material on which it is placed, the feasibility demonstrated only for a limited set of selected materials.

Researchers have explored several methods for inferring the material placed underneath a mobile device using customized electronic hardware. Lightweight Material Detection [5] and SpecTrans [14] may be capable of recognizing the materials using the light reflected by specular, textureless, and transparent surfaces. However, both Lightweight Material Detection and SpecTrans work by using custom electronics, such as multi-spectral LEDs and high-speed light-to-frequency converters. Magic finger [21] uses a micro camera placed on the tip of a finger to capture images of the textures for different objects, and then uses a classifying algorithm to identify the corresponding materials. HyperCam [3] uses a sophisticated camera system capable of capturing multi-spectral images, providing high detection of salient textured surfaces for disambiguating objects and organic surfaces. SCiO [11] is a consumer device that uses Near Infra Red (NIR) to sense materials, mainly for testing the quality of food and pills. RadarCat [22] uses a custom radar chip (the Google Soli sensor) to capture the spectrum of reflected continuous waves with modulated frequencies for recognizing materials and objects. All of the aforementioned methods may require custom hardware.

On the other hand, past research also includes techniques that use only the built-in sensors and actuators of a mobile device. For example, Vibrotactor [7] relies on the vibration echoes captured by the microphone and accelerometer to infer the surface where the phone is placed. Similarly, SurfaceSense [1] combines multiple sensors such as the accelerometer, magnetometer and vibration actuator. However, these methods might distract the users due to the usage of vibrations, and also may not be able to disambiguate different materials with similar stiffness. Finally, sound or acoustic signals may also be used to infer the material on which the phone is placed. Using inaudible acoustic signal with a phone's speakers and sensing its reflections with the phone's microphones, EchoTag [16] can tag and remember indoor locations, while Hasegawa et al. [6] uses the same technique for material detection. Sweep Sense [9] also uses a similar method, but focuses on new contextual input methods rather than material recognition.

Alternative sensing techniques involve the usage of different sensors, often combining those already present on the mobile device with additional custom hardware. For example, Phoneprioception [18] uses a combination of the phone's built-in sensors with a custom capacitive grid and a multi-spectral sensor to recognize the surface material on which the phone is placed or kept.

Some work leveraged the phone camera as a main sensing unit. HemaApp [17] uses the front camera for blood screening on the finger. It uses a custom LED and UV/IR ring for the light source. CapCam [20] uses the phone's rear camera to perform pairing and data transmission between a touch display and the mobile device. Low et al. [10] uses the rear camera and the flash to detect pressure force applied by the user's palm. Finally, Cell Phone Spectrophotometer [15] combines the rear camera and transmission diffraction grating as a spectrometer.

Spectroscopy enables understanding of emissions and of reflectance optical properties of materials, separating the color components across the visible spectrum. The surfaces of different objects have unique color spectral signatures that may be used to help classify objects of interest. Spectrometers generally use diffraction grating to take incoming light from a broad spectrum and spread it out like a rainbow across a charge-coupled device (CCD) to then measure the contribution from each of the small wavelength bands across the whole visible spectrum (the spectrometer described below has sub nanometer resolution).

The spectrometer may therefore be used to detect the emission spectrum from any emitted light. Alternatively, the spectrometer may emit white light and collect the light reflection through fibre optic cables, and then measure the reflectance spectrum. By analyzing the reflected spectrum of the surface of different materials, it may be possible to gain an understanding of the material's optical properties (i.e., light scattering and reflectivity), and then use these to train a machine learning classifier, so to recognize spectrally distinctive characteristics.

Some known technology of material and surface sensing relies on expensive equipment such as a spectrometer, or invasive methods that may require decomposing the material. Decomposing the material may not always be feasible.

Surface sensing for context aware computing may use custom electronics, for example multiple LEDs of different wavelengths for emitting infra red and visible multi spectra light source and a light to frequency converter to capture reflected light.

### SUMMARY

In a first aspect, there is provided a method comprising: positioning a display screen and surface of interest such that the display screen faces the surface of interest; emitting light by the display screen, wherein at least part of the emitted light is reflected by the surface of interest; receiving, by a camera, light reflected from the surface of interest thereby to generate at least one image; and processing the at least one image to determine at least one property of the surface of interest.

The display screen and camera may form part of a mobile phone or any other suitable mobile device, for example a mobile computing device, optionally at least one of a tablet computer, smartwatch, smartphone, wearable computing device. The display screen and camera may be located on the same side of the mobile phone. The display screen may be located on the front surface of the mobile phone. The camera may be a front-facing camera of the mobile phone. Positioning the display screen and surface of interest may comprise placing the phone face-down on the surface of interest, i.e. with the front face of the mobile phone facing the surface of interest. The method may further comprise determining based on the determined property of the surface of interest a location of the phone, for example whether the phone is on a table, on a sofa, or in a pocket.

The display screen may comprise one or more screens of a dual-screen or multi-screen mobile device. The display screen may comprise a foldable screen. The display screen may comprise a curved screen.

The light emitted by the display screen may comprise visible light. The light emitted by the display screen may comprise infrared light and/or ultraviolet light. The camera may comprise an infrared camera and/or an ultraviolet camera. A sensor of the camera may be sensitive to infrared light and/or ultraviolet light. A sensor of the camera may be sensitive to infrared light and/or ultraviolet light in addition to visible light.

Emitting the light by the display screen may comprise successively emitting light of each of a plurality of different colours of light. The at least one image may comprise a respective image generated for each of the plurality of different colours of light. The plurality of different colours of light may comprise at least some of white, red, green, blue, cyan, yellow and magenta light. The display screen may act as a multi-spectral light source. Each colour of light may be emitted for a respective selected duration. Each colour of light may be emitted for less than 1 second, optionally less than 0.5 seconds, further optionally less than 0.2 seconds, further optionally less than 0.1 seconds.

At least some of different colours of light may comprise infrared light. At least some of the different colours of light may comprise ultraviolet light. The processing of the at least one image to determine at least one property of the surface of interest may be performed in dependence on at least one property of the light emitted by the display screen. The method may comprise controlling the display so that the emitted light has at least one selected or desired property, for example at least one of a selected colour, wavelength or range of wavelengths, brightness, or a selected or desired variation with display screen position or time of said selected or desired property.

The display screen may switch between a plurality of states. In each state, the display screen may emit light of a predetermined colour or combination of colours. The method may comprise switching between at least 4 states, optionally at least 7 states. The display screen may be in each of the states for less than 1 second, optionally less than 0.5 seconds, further optionally less than 0.2 seconds, further optionally less than 0.1 seconds.

The at least one image may be an unfocused image. The camera may comprise at least one lens. The camera may further comprise a focal mechanism configured to adjust a focus of the at least one lens. The camera may further comprise a sensor array configured to receive light that has been received through an aperture of the camera and has passed through the at least one lens. The sensor array may comprise electronics configured to convert light received by sensors of the sensor array into electrical signals. The camera may further comprise a processor configured to process signals output by the sensor array.

A distance between the display screen and the surface of interest may be less than a focal length of the lens. A distance between the display screen and the surface of interest may be less than a minimum focal length of the camera. Positioning the display screen and surface of interest such that a distance between them is less than the focal length of the camera lens may result in an unfocused image being acquired by the camera. The unfocused image may be such that a person viewing the image would not be able to discern features of the surface of interest.

The camera may acquire images at between 10 frames per second and 1000 frames per second. The camera may acquire images at, for example, between 30 and 60 frames per second. The display screen may be in each of the states for the duration of one or more frames, optionally for at least 2 frames, further optionally for at least 5 frames.

The or each image may comprise an array of image values, for example a two-dimensional array of image values corresponding to a two-dimensional array of pixels of the camera. The image values may be representative of the intensity and/or colour of light received by each pixel.

The display screen may illuminate an extended region of the surface of interest. The camera may capture light reflected from an extended region of the surface of interest. By capturing light reflected from an extended region, more information may be obtained than if capturing light from a smaller area (for example, using a single light sensor).

The processing of the at least one image may comprise, for the or each image, determining a respective amplitude for each of a plurality of colours. The processing of the at least one image may comprise, for the or each image, obtaining a histogram of amplitude versus colour. The processing of the at least one image may comprise analysing a reflectance spectrum.

The processing of the at least one image may comprise extracting at least one feature from the or each image. The at least one feature may comprise at least one bin of at least one histogram. The at least one feature may comprise a respective amplitude for each of a plurality of colour bins. The at least one feature may comprise a gradient. The at least one feature may comprise at least one spatial feature.

The mobile device may further comprise a sensor that is configured to provide spectral discrimination. The at least one feature may comprise at least one spectral feature. The processing of the at least one image may comprise texture analysis. The processing of the at least one image may comprise pattern recognition. The processing of the at least one image may comprise at least one of: extracting Local Binary Patterns (LBP), using Scale Invariant Feature Transform (SIFT), using Histogram of Oriented Gradients features (HOG).

The at least one property of the surface of interest may comprise at least one of a material of the surface of interest, a colour of the surface of interest, a texture of the surface of interest.

The determining of the at least one property of the surface may comprise performing a classification of at least one of a material of the surface, a colour of the surface, a texture of the surface. The classification may be based on the extracted at least one feature. The classification may be performed by a machine learning classifier. The machine learning classifier may be trained to classify a plurality of different surfaces. The machine learning classifier may be trained to classify a plurality of different surfaces as specified by a user, for example the user's own furniture, furnishings or clothing. The classification may be performed in real time.

The display screen and camera may form part of a mobile device which also comprises a processor. The processor may be configured to apply the machine learning classifier to the at least one image. The processor may be configured to apply the machine learning classifier to at least one feature extracted from the at least one image.

The positioning of the display screen may comprise positioning the display screen such that a surface of the display screen is at least 1 mm from the surface of interest, optionally at least 2 mm, further optionally at least 3 mm. The positioning of the display screen may comprise positioning the display screen such that a surface of the display screen is less than 10 mm from the surface of interest, optionally less than 5 mm, further optionally less than 4 mm, further optionally less than 3 mm. The positioning of the display screen may comprise positioning the display screen such that a surface of the display screen is within a selected distance range.

Positioning the display screen and surface of interest such that the display screen faces the surface of interest may comprise positioning the display screen near the surface of interest, or positioning the surface of interest near the display screen. Positioning the display screen and surface of interest such that the display screen faces the surface of interest may comprise positioning the display screen and surface of interest such that the display screen and surface of interest are substantially parallel.

The display screen and surface of interest may remain substantially static while the reflected light is received and/or while the at least one image is generated.

The method may further comprise controlling a brightness of the display screen. The brightness may be controlled in dependence on a property of the surface of interest. For example, a higher brightness may be used for a darker surface. The controlling of the brightness may comprise disabling an automatic brightness setting.

The method may further comprise displaying to a user at least one of: the at least one image; a classification of the surface of interest; at least one feature extracted from the or each image.

The method may further comprise determining based on the determined property of the surface of interest an operating mode of a computer program or device. The method may further comprise determining based on the classification data an input to a computer program or device, for example a command.

The method may further comprise selecting one of a set of actions in dependence on the determined property of the surface of interest. The set of actions may comprise a set of instructions and the selecting may comprise selecting at least one instruction of the set of instructions. The set of actions may comprise, for example, music controls or lighting controls. The set of actions may comprise at least one of audio recording, speech recognition, calendar setting. The set of actions may comprise setting a timer. The set of actions may comprise launching an application. The set of actions may comprise at least one of making a phone call, sending phone calls to voice mail, sending phone calls to a Bluetooth device. The set of actions may comprise phone settings or settings of a further device, for example a TV, music player, lighting system or sound system.

The method may further comprise positioning the display screen on a further surface and determining a property of the further surface. The method may comprise selecting a further action in dependence on the property of the further surface. Therefore, by moving a device comprising the display screen (for example, a phone) a user may control the device or a further device in an unobtrusive manner.

The method may further comprise receiving data from a sensor. The determining of the at least one property of the sensor may be in dependence on the data from the sensor. The selecting of the one of the set of actions may be in dependence on the data from the sensor. The sensor may comprise at least one of an inertial measurement unit, a magnetometer, a microphone, an orientation sensor, a proximity sensor.

In a second aspect, which may be provided independently, there is provided an apparatus comprising: a display screen configured to emit light; a camera configured to receive light emitted from the display screen and reflected from a surface of interest thereby to generate at least one image; and a processor configured to process the at least one image to determine at least one property of the surface of interest.

The display screen and camera may form part of a mobile phone. The processor may form part of the mobile phone. The processor may comprise or form part of a computing device, for example a personal computer, server, laptop, or tablet.

The camera may be a front-facing mobile phone camera.

The display screen may comprise at least one of an LED screen, an OLED screen, an LCD screen. The display screen may be backlit. The display screen may comprise an array of pixels, for example an array of thousands of pixels. The light may be emitted by thousands of pixels simultaneously. The display screen may comprise an array of millions of pixels, optionally at least one million pixels, optionally between one million and ten million pixels. The light may be emitted by said pixels simultaneously.

The display screen may provide an extended light source which illuminates an extended region of the surface of interest. By using an extended light source, more information about the surface may be obtained than if, for example, a point light source were used. For example, material variations may be captured.

The light reflected from the surface of interest may be emitted by a portion of the display screen. A further portion of the display screen may be used to display captured images and/or user instructions.

The apparatus may further comprise a spacing device configured to space the display screen apart from the surface of interest. The spacing device may comprise or form part of a phone case. The phone case may be further configured to at least partially surround the phone.

The spacing device may be configured to at least partially block ambient light. The spacing device may surround the display screen and/or camera. When placed on the surface, the spacing device may enclose a detection area into which the light is emitted and from which the reflected light is received. The spacing device may be dark in colour, for example black.

The spacing device may be configured to hold the display screen at a distance from the surface of interest when the spacing device is in contact with the surface of interest. The distance may comprise at least 1 mm, optionally at least 2 mm, further optionally at least 3 mm. The distance may be less than 10 mm, optionally less than 5 mm, further optionally less than 4 mm, further optionally less than 3 mm.

In a third aspect, which may be provided independently, there is provided a mobile phone comprising: a display screen configured to emit light; a camera configured to receive light emitted from the display screen and reflected from a surface of interest thereby to generate at least one image; and a processor configured to process the at least one image to determine at least one property of the surface of interest.

Integrating the display screen, camera and processor into a mobile phone may provide improved mobile phone functionality, for example context-aware interaction. The functionality may be provided using components that already form part of a conventional mobile phone, without using custom electronics or external components.

There may be provided a mobile computing device comprising an apparatus as claimed or described herein. The mobile computing device may comprise at least one of a smart phone, a smart watch, a wearable computing device. There may be provided a remote controller, clock or mug comprising an apparatus as claimed or described herein.

There may be provided an apparatus or method substantially as described herein with reference to the accompanying drawings.

Any feature in one aspect of the invention may be applied to other aspects of the invention, in any appropriate combination. For example, apparatus features may be applied to method features and vice versa.

### BRIEF DESCRIPTION OF THE DRAWINGS

Embodiments of the invention are now described, by way of non-limiting examples, and are illustrated in the following figures, in which:—

FIG. 1a shows a phone facing down;

FIG. 1b shows a phone, showing a main light source and captured images;

FIG. 1c shows a UI of a classification server;

FIG. 1d shows three 3D printed phone cases having different heights;

FIG. 2 is a grid showing a plurality of sample materials with similar colours and images captured from those sample materials, where the upper half of FIG. 2 comprises sample materials that are white, and the lower half of FIG. 2 comprises sample materials that are brown and red;

FIG. 3 is a grid showing a plurality of sample materials and images captured from those sample materials, where the upper half of FIG. 2 comprises sample materials that are metallic, and the lower half of FIG. 2 comprises sample materials that are textured;

FIG. 4 is a set of colour histograms for different materials, where each x-axis represents 64 colour bins and each y axis represents amplitude and is automatically scaled;

FIG. 5 is a pair of plots showing measured screen emission spectra for a Galaxy S6 (top) and Nexus 5 (bottom);

FIG. 6 is a plot showing results for colour detection and errors;

FIG. 7 is a pair of confusion matrices, the top confusion matrix being for an experiment using a spectrometer, and the bottom confusion matrix being for an experiment using a phone-based system in accordance with an embodiment;

FIG. 8 is a schematic diagram of an apparatus in accordance with an embodiment;

FIG. 9 is a confusion matrix for an experiment using a spectrometer to classify Pantone color cards.

### DETAILED DESCRIPTION

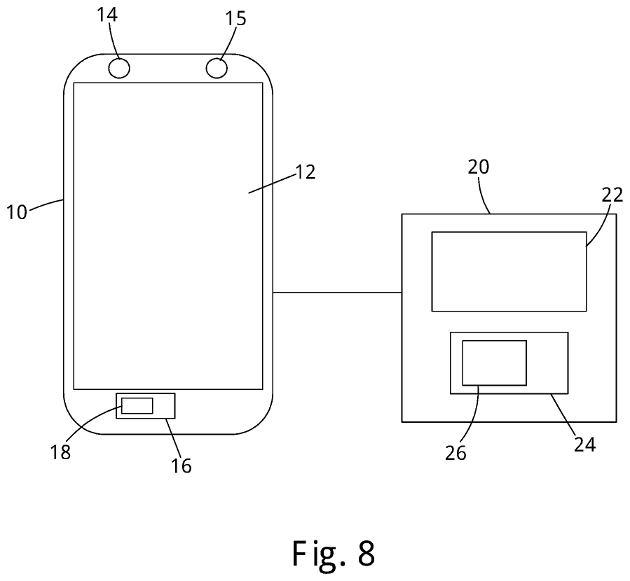

FIG. 8 is a schematic diagram of an apparatus in accordance with an embodiment. The apparatus and/or software run on the apparatus may be referred to as SpeCam.

The apparatus comprises a mobile phone 10, which may also be referred to as a cellphone. The phone 10 comprises a screen 12 which may also be referred to as a display. The phone 10 further comprises a front-facing camera 14. The front-facing camera 14 is a camera that faces towards the user when the user is viewing the screen 12. The phone 10 may also comprise a rear-facing camera (not shown) which faces away from the user when the user is viewing the screen 12. The phone 10 further comprises a built-in light sensor 15.

The phone 10 further comprises a processor 16. The processor 16 is configured to run software 18, which may be referred to as a client application.

The phone 10 may also comprise any other appropriate components of a phone in addition to those shown, for example a battery, various circuit boards, at least one antenna, a microphone, a speaker and various sensors.

Although components 12, 14, 15, 16 of the phone 10 are illustrated in particular positions in the schematic diagram of FIG. 8, these positions are shown for the purposes of illustration. In embodiments, each of the components 12, 14, 15, 16 may be implemented in any suitable part of the phone 10. For example, different types of phone (for example, different makes and models) may have differently-positioned front-facing cameras.

The phone 10 is connected to a server 20. The connection between the phone 10 and the server 20 may be wired or wireless. In the present embodiment, the server 20 comprises a personal computer (PC). In other embodiments, the server 20 may comprise any appropriate computing device, for example any computer, laptop, or tablet. In further embodiments, functionality of the server 20 may be provided by the processor 16 or by a further processor (not shown) within the phone 10.

The server 20 comprises a server display 22 and a processor 24. The processor 24 is configured to run software 26, which may be referred to as a server application.

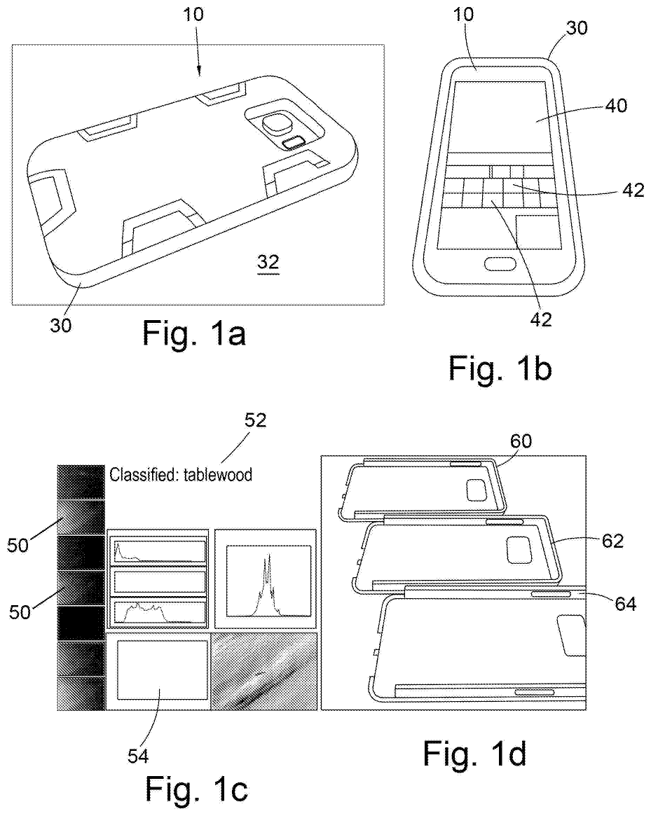

In use, the phone 10 is housed in a case 30, which may be referred to as a bumper case. The phone 10 is placed face down on a surface, such that the screen 12 faces the surface. FIG. 1a shows a phone 10 in a case 30, which is placed face down on a wooden surface 32.

When the phone is placed facing down (FIG. 1a), the phone's display 12 rapidly changes the display color, and then the camera 14 captures the reflected light (FIG. 1b). In effect, the display acts as a multi-spectral light source. In FIG. 1a, the phone 10 is facing down while the screen (not shown) flashes different colors and the camera (not shown) captures images of the reflected light.

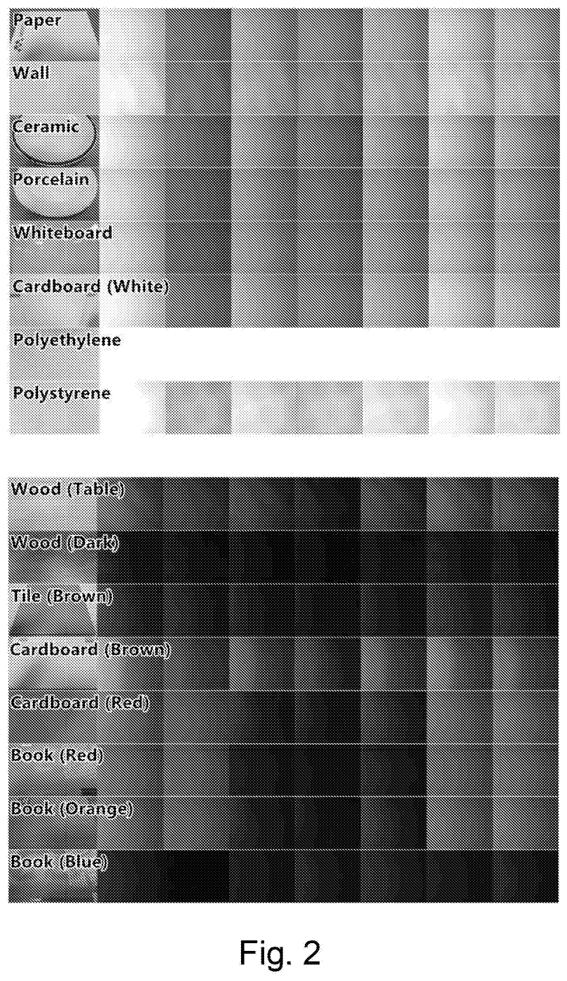

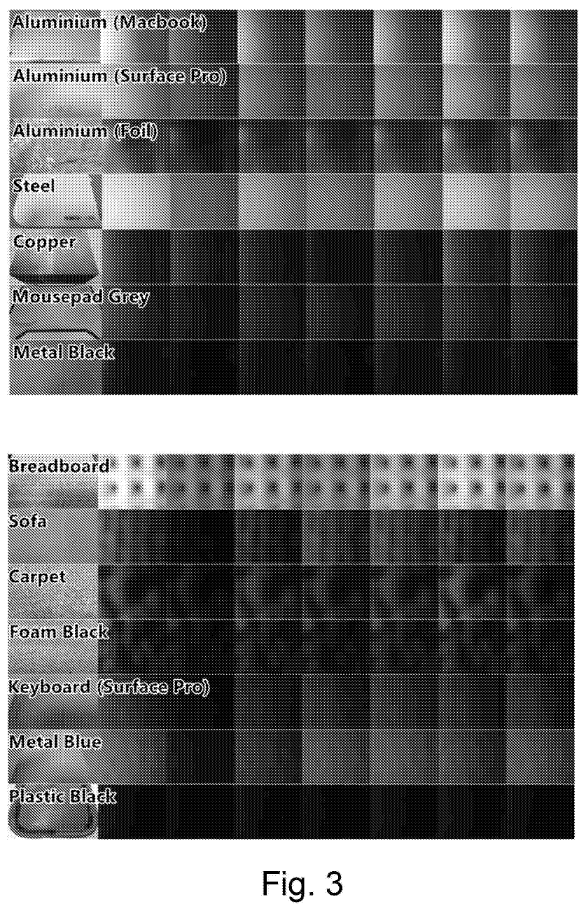

Different types of surface materials have varying structural and spectral properties (e.g., specular or diffuse, glossy or matte), resulting in different ways in which light is reflected from the surface. The front-facing camera 14 of the device 10 is used to capture an image for each of the colors emitted, as shown in FIGS. 2 and 3 (which are described further below).

In FIG. 1b, the screen 12 of the phone 10 displays a user interface (UI) of the phone 10. The UI comprises a main light source 40 and a set of captured images 42. Since in use the camera 14 is positioned close to the surface, the captured images 42 may not be in focus. The captured images 42 may represent light reflected from the surface. The main light source 40 is a part of the screen that, in this embodiment, is used to produce each of a series of colours for illuminating the surface.

The different reflection of light from different light surfaces may allow us to uniquely identify a particular material, and associate it with a particular placement. For example, a wooden table, sofa or an aluminium laptop.

Texture analysis or pattern recognition on the captured images may also be performed. For example, texture analysis or pattern recognition may be performed using advanced computer vision techniques, such as extracting the Local Binary Patterns (LBP), or using Scale Invariant Feature Transform (SIFT), or Histogram of Oriented Gradients features (HOG).

In the present embodiment, the front-facing camera 14 of a smartphone 10 is being employed in a face down condition. Hence, the distance between the camera and the target surface will be small. Such cameras may typically not be designed to obtain an image with a sharp focus due to such a near distance between the camera 14 and the target surface.

Additionally, when the phone 10 is placed facing downwards, the front-facing camera 14 may be touching the surface or close to touching the surface. The nearness of the front-facing camera 14 to the surface may result in almost no light entering the camera.

Therefore, we introduce a small gap between the camera 14 and the surface. Fortunately, bumper cases, used to protect phones from damage when falling, may easily be employed to produce a small gap between the camera 14 and the surface when the phone 10 is placed face down. Bumper cases are popular and introduce a small gap between the screen and the surface in order to protect the device from damage.

Many commercially available bumper cases raise the screen 1 mm to 2 mm from the contact surface, in order to keep the overall dimensions small. A rugged version of a bumper case may raise the screen by a greater distance for more protection.

During preliminary tests with several bumper cases with 1 mm to 2 mm raised lips, we found that it is possible to recognize some materials, but they are not adequate in recognizing dark and diffuse materials, due to the extremely low light reflectance captured by the front-facing camera.

Therefore, we 3D-printed several modified bumper cases for the phone and experimentally tested different heights for the gap. FIG. 1d shows three 3D printed cases 60, 62, 64 that were printed with different heights for a pilot study. Each bumper case 60, 62, 64 has a different height of lip and therefore produces a different gap between the screen 12 and surface when the phone 10 is placed face-down on a surface.

Our results indicated that, in the circumstances of the study, 3 mm was the minimum feasible height for consistent performance with the darkest material we used in our study—the black plastic tray.

A larger gap between the screen 12 and the surface may allow more light to enter the camera and may allow the camera to obtain a sharper focus, potentially allowing advanced texture analysis and pattern recognition techniques. However, a very thick bumper case may not be aesthetically pleasing for the user, and thus may be considered less practical. Hence we decided for testing to use a rugged bumper case which we purchased off-the-shelf (ULAK1 3in1 Shockproof case 30 as shown in FIG. 1a). This bumper case introduced a 3 mm gap and allows the front-facing camera 14 to capture enough light even on dark and diffuse materials, as can be seen in FIG. 3 (see the bottom of each of the two grids of FIG. 3).

Although a bumper case was used in the experiments described, in other embodiments any suitable spacing device may be used to introduce a gap between the screen and the surface.

In some embodiments, each image captured is an unfocused image. The device 10 is placed such that a distance from the surface to the camera is less than a focal length of a lens of the front-facing camera 14.

In other embodiments, each image captured may be partially or wholly in focus. For example, in some embodiments, the lens of the camera may be a macro lens. The macro lens may be configured to obtain focused images of objects positioned close to the camera.

SpeCam comprises a client application 18 running on a smartphone 10 and a server application 26 running on a PC 20. We implemented the client system in an Android smartphone, using the Android Camera API [2]. In some embodiments, the SpeCam system is self-contained and runs in the smartphone.

The phone 10 emits multi-spectral light by flashing the OLED screen 12 and capturing the reflected light/image using the front-facing camera 14 (FIG. 1b). To support darker material, we increased the screen brightness to the maximum level and disabled the auto-brightness feature.

Images are captured on the phone 10 and sent to the server 20 through WiFi for real-time classification.

For fast prototyping, our classifier server 20 is implemented on a PC (FIG. 1c), using a wrapper for the OpenCV toolkit.

FIG. 1c shows a user interface (UI) of the classification server 20, showing the received images 50, the classification results 52 on top and the extracted features 54 (color histogram, gradient, etc). The UI may be displayed on the server display screen 22. The received images 50 may be images obtained by the phone 10 using the camera 14 when the surface is illuminated by different colours.

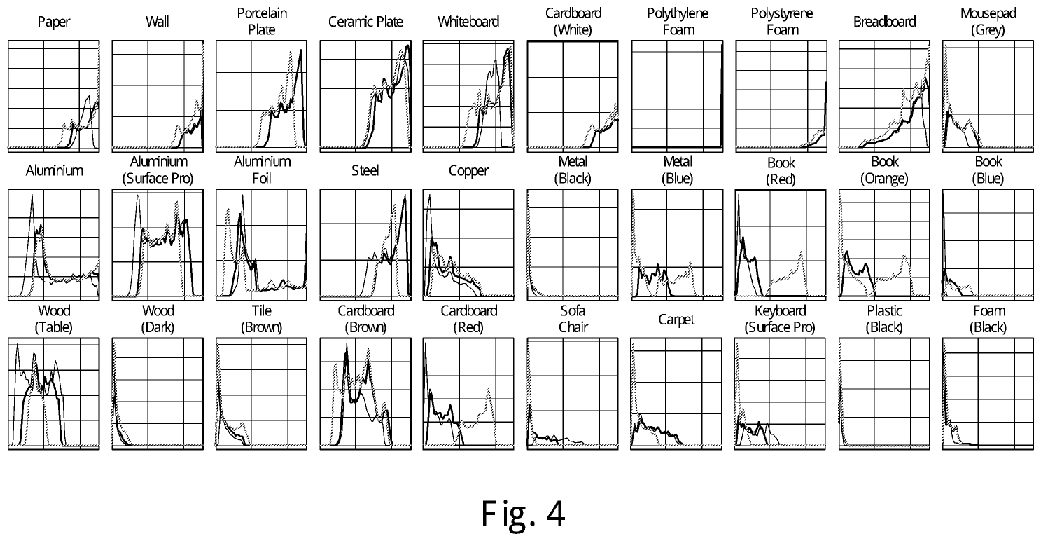

The server side also performs feature extraction. Currently we use the 3 channels color histogram (64 bins) as the main features. The 3 channels color histograms may be unique to each material and the overall trend can be seen in FIG. 4.

FIG. 4 shows color histograms of various materials, which may be visually similar (for example, may appear similar when viewed by a user). The top row of histograms are for white and grey materials. The middle row of histograms are for metal materials and books. The bottom row of histograms are for brown, dark and textured materials.

For each of the histograms in FIG. 4, the x-axis represents the 64 color bins. The y-axis represents the amplitude and is automatically scaled for clarity, which can be seen in the varying grid. Note that FIG. 4 shows the color histogram of the white image only. Using more features from other color may improve the accuracy.

We evaluated different sets of features, depending on the amount of color images we used (1, 4 or 7). For example, 4 colors×3 channels×64 bins=768 features.

We also captured the reflected light intensity using the built-in light sensor 15 in the front of the phone, yielding 7 features for 7 color images. However, our initial tests show that it is very inaccurate in classifying material, which aligns with prior observations [5].

We also calculate the image gradient using the Sobel operator on both the x and y direction, using a kernel size of 11. Then we extract the histogram of the gradient image (FIG. 1c, bottom right) with 64 bins. However, when using the gradient as extra features, we found that the classification accuracy actually decreases. Therefore, we removed them from our final evaluation. As we will show later, using only the color histogram alone (FIG. 4) may yield very high accuracy.

To validate our proposed approach and to evaluate its feasibility and accuracy, we conducted a two-part evaluation—i) color and ii) material classification, using both our proposed system and a spectrometer for providing ground truth. First we describe the apparatus we used—a) a spectrometer and b) our SpeCam smartphone-based system.

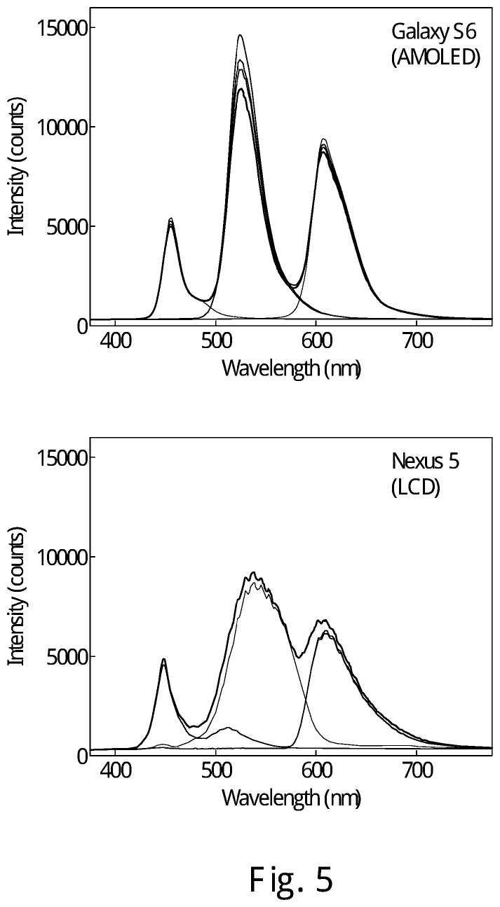

Before testing SpeCam, we collected ground truth data using a spectrometer (Ocean Optics Flame-S-VIS-NIR Spectrometer) which has an optical wavelength range from 350-1000 nm. We recorded the spectrum of the outgoing light from the phones at each color used for phone surface sensing. By placing the spectrometer on two phones with different displays: the Samsung Galaxy S6 and Nexus 5, we recorded the spectrum of the phone's display, as shown in FIG. 5.

FIG. 5 shows measured screen emission spectra for a Galaxy S6 (AMOLED) and Nexus 5 (LCD). The spectra for the Galaxy S6 are shown in the upper plot of FIG. 5. The spectra for the Nexus 5 are shown in the lower plot of FIG. 5. The different lines of the plots are representative of different screen colours. In colour, the line colors match with the screen colors (e.g., yellow line represents the yellow screen) except the black line which represents a white screen. These spectra show the wavelength range of the three color bands, which are activated in different proportions for different colors.

Using the spectrometer, we also recorded the spectrum of the light reflected for all the objects and printed color sheets. We used a white light source (Ocean Optics Halogen Light Source HL-2000-FHSA) and a fibre optic cable (Ocean Optics QR400-7-VIS-BX Premium 400 um Reflection Probe) to transmit the light to the object's surface, and used a fibre optic cable in the centre of the output fibers to measure reflected light.

For each object and color sheet, the fibre bundle was positioned 3 mm above the surface at random locations for ten times, and during each time, the data for each spectrum was acquired.

The exposure time for the color sheets (experiment 1) and objects (experiment 2) is 20 ms and each spectrum is an average of 10 scans. Increasing the exposure time led to saturation effects for highly reflective objects, such as the foil, therefore we averaged 10 scans as to increase the signal to noise ratio. We noted that when acquiring the spectrum from certain objects with inconsistent surfaces the intensity varied at different positions. This was particularly true for highly reflective objects with a warped surface and smudges (such as the copper heat-sink blocks).

For our smartphone-based system, we decided to use the Samsung Galaxy S6 smartphone with an AMOLED panel (FIG. 5). With the phone 10 facing down, the screen flashes 7 colors (white, red, green, blue, cyan, yellow and magenta) in quick succession and the camera captures the images, which comprise reflected light and surface properties. The whole process takes roughly 1 second. We used a resolution of 640×480 (higher resolution is possible but we found negligible improvements). The images are sent to the server 20 through WiFi for real-time classification and are also stored in the phone 10 for eventual offline analysis.

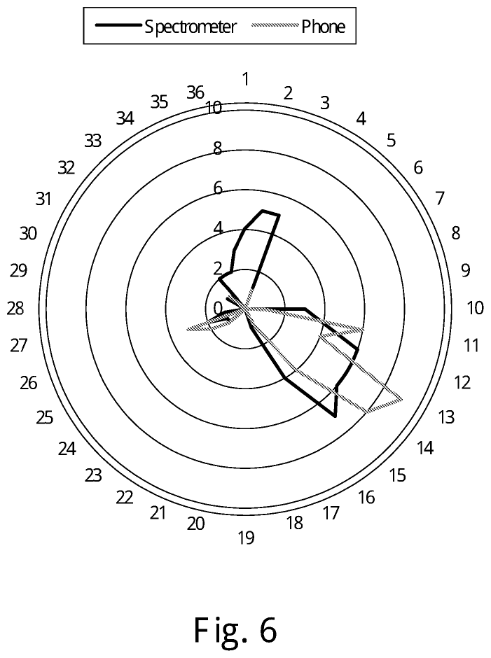

We printed 36 sheets of different colors on A4 paper. Each color differs by 10 degrees in the hue space, and have constant saturation and brightness (set at 100%). We then sampled the sheet surface color using both a spectrometer and our phone-based system. Data was collected at 10 random positions on the sheet. We used the WEKA toolkit [4] to perform offline analysis, with 10-fold cross-validation using an SVM classifier. We achieve 82.12% using the spectrometer data, and 88.61% accuracy using our camera-based system. We observed that errors only occur near the three dominant colors (RGB), while the rest are very accurate, as shown in FIG. 6.

FIG. 6 shows results for color detection. The black and white lines show where error occurs for the spectrometer and the phone, respectively. The inner numbers are the number of errors (out of 10) and the outer numbers are the hue angle (divided by 10).

We can observe that the errors occur near to the three dominant colors, especially for green color.

It is worth noting that both the spectrometer and our system resulted in more errors around the pure RGB values, indicating that the problem may be related to the printed colored sheets used for the color detection.

Therefore, we proceed to test the limit of accuracy for non-dominant colors. We selected a color range outside the dominant colors, i.e., the orange color and printed 10 sheets of this color, differing by only 2 degrees each along the hue. We used a similar process as the one above (10 random positions, 10-fold cross-validation) and we achieved 73.64% (spectrometer) and 63.64% (camera) accuracy. We then increased the distance to 4 degrees apart, and the result increases to 90.0% (spectrometer) and 91.67% (camera) accuracy.

With this result, we are confident that our system can recognize colors at 4 degrees apart outside the dominant colors and 10 degrees apart near the dominant color (RGB), and hence it can recognize surface materials—the subject of the next experiment.

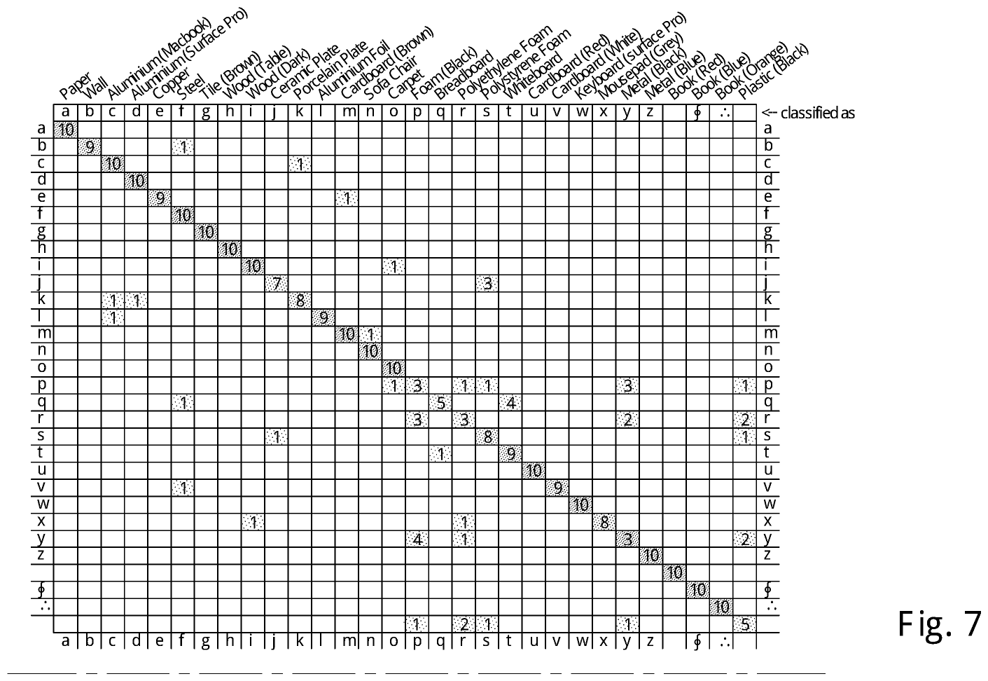

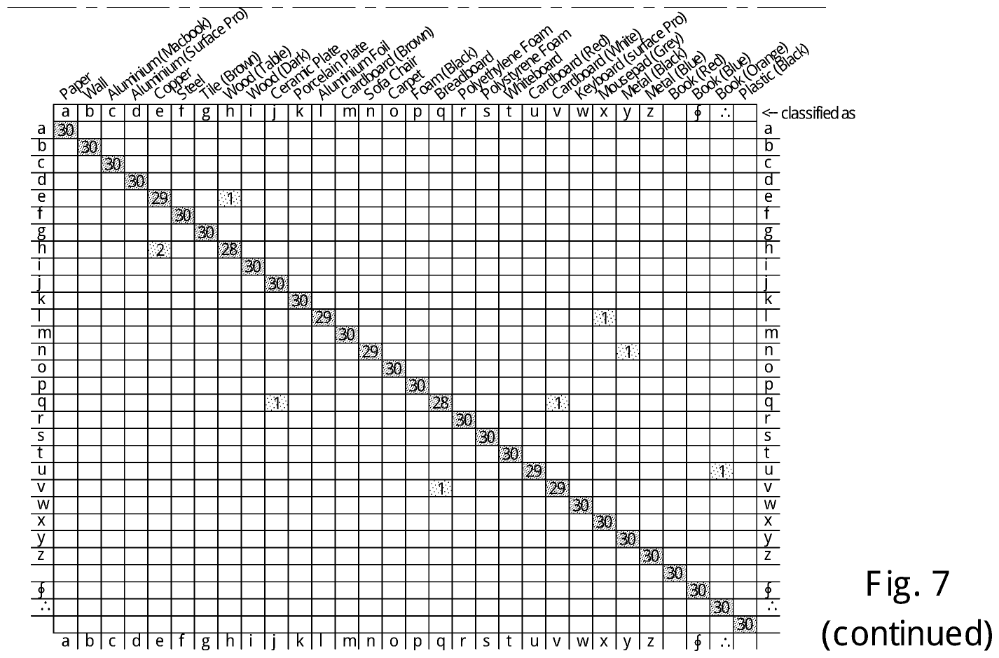

We gathered 30 materials selected from common objects found in a domestic environment, as shown in FIG. 2 and FIG. 3. With the data collected using the spectrometer (30 objects, collected at 10 random positions for each object), we evaluated the system using 10-fold cross-validation and achieve 78.22% accuracy (FIG. 7 upper confusion matrix). The upper part of FIG. 7 shows a confusion matrix for the experiment using spectrometer with leave-one-out evaluation, using SVM classifier 2048 features along the wavelength.

We collected data of the materials spanning across two days using our phone-based system, at random positions. It resulted in 6×5=30 data points for each material. The dataset is publicly available at https://github.com/tcboy88/SpeCam. We evaluated the system using both the leave-one-out process and 10-fold cross-validation. We also evaluated it using different feature sets, e.g., 1 color, 4 colors and 7 colors. The results are shown in table 1 and the lower confusion matrix in FIG. 7. The lower part of FIG. 7 shows a confusion matrix for the experiment using SpeCam phone-based system with leave-one-out evaluation, using SVM classifier with features extracted from 4 color images, e.g., 768 features. Zeros are omitted for clarity.

We experimented with extra features such as the gradient and LBP. However, it reduced the recognition accuracy. Since the accuracy of our system is high using just the color histogram, we discarded the extra features. We observe that the accuracy increases along with increasing numbers of colors used, in both leave-one-out and 10-fold cross-validation (table 1).

TABLE 1

Test conditions

| Evaluation using SVM classifier | 1 color | 4 colors | 7 colors |
|---|---|---|---|
| Leave-one-out | 97.78% | 99.00% | 99.11% |
| 10-fold cross-validation | 98.22% | 99.33% | 99.44% |

Table 1 shows evaluation results for the phone-based system on surface material recognition, using different sets of features (1, 4 or 7 colors).

For color recognition, there was difficulty in differentiating color with high similarity near the three dominant colors (red, green and blue), especially for the green color (FIG. 6). The result using a spectrometer is not perfect either, and is in fact slightly lower than our camera-based system. There are a few possible explanations: we printed the color sheets on A4 papers using a laser printer. 1) The default color range of the laser printer might be limited or calibrated not precisely enough to account for such small differences. 2) We noticed that the printing is not perfectly uniform and the paper surface is slightly bumpy. Since a spectrometer only collects light from a single point, it is unable to capture the variance due to this non-uniform printing. Whereas a camera captures image from a larger field of view, which may be less susceptible to the non-uniform printing issue. In future we plan to conduct an evaluation with high-quality color palettes, or to use a color supporting face-down interaction, SpeCam can support calibrated display as the test surface.

For surface material recognition, the overall accuracy of our system was found to be very high, and to yield better results than the spectrometer. We attribute these results to the limitation of the spectrometer which uses a single point measurement, and therefore cannot account for the overall surface material properties such as texture, gradient and reflection. For example, this can be seen in the center of the confusion matrix (FIG. 7 upper), where breadboard and foams cannot be accurately recognized using a spectrometer. For the phone-based system, we do observe that materials of similar colors induce some confusion (FIG. 7 lower). Visually inspecting the color histogram (FIG. 4) we can see similarities between white materials. Surprisingly, dark materials such as black plastic, black metal and black foam were very accurately recognized (FIG. 3).

In order to capture the weak light reflected from dark materials, we used a fixed, maximum exposure on the camera settings. This caused over exposed images for certain materials, such as polyethylene, which resulted in white images for all colors (FIG. 2 (polyethylene)). In fact, when using a low exposure, it was found to be possible to get useful images for polyethylene, but then it would not capture enough light for darker materials. In future work we will try adaptive exposure to account for this issue.

We realized that different phones have different panel types and maximum brightness. In our initial test, the LCD panel (Nexus 5) with back-light allows the camera to capture more light than the OLED panel (Galaxy S6), thus it may enable better recognition of darker materials. However, from FIG. 5 we can see that the OLED has purer spectral bands which would enable better spectral distinctions.

In further embodiments, any suitable device may be used to emit light. The device may emit light at many chosen wavelengths, for example at multiple optical wavelengths from the ultraviolet through the visible to the infrared wavelength ranges.

The device may include a camera sensor which is sensitive to the chosen wavelengths. The measurements from the camera sensor may be supplemented by measurements from a sensor which is capable of spectral discrimination.

A combination of the spectral content of the light from the device and the spectral sensitivity to light from the sensor may be used in addition to spatial features from the camera image to aid object identification. Both the spatial and the spectral detail may be used to improve accuracy where the device is in close proximity to the object.

Currently the wavelength range for typical low-cost smartphones screens and camera sensors may typically be within the visible spectrum. However, high end devices have active infrared proximity sensors and infrared depth sensing which are capable of extending the wavelength range into the infrared. It is expected that these high end features may be available on low cost devices in the future.

In the future hyperspectral imaging, for example using liquid crystal tuneable filters as part of the camera sensor, may be incorporated and may enable improved sensitivity to narrower spectral bands. In some embodiments, hyperspectral imaging may be used in such a device to improve the spectral detail and be included as more features for the machine learning classifier.

When considering SpeCam as a new type of material-detection sensor, then potentially a large number of applications and scenarios can be considered. One can envision the technique being used as an accurate color picker for a tangible painting application. Picking a matching color or texture from real world and using it in painting applications may often be tedious if not impossible. Our technique may act as a probe that connects the real world and the virtual world, for seamlessly picking colors and textures.

However, it is the uses of SpeCam in typical mobile device settings that may open up a wide range of potential applications. For example, the placement of a device may afford new forms of interaction that supports eyes-free and single-handed use, simply through the placement of the device on different surfaces

Being able to determine the location of a device with high precision may offer several unexplored opportunities of interaction. For example, a user could transfer information by placing a phone on a computer, or trigger specific applications on the device by placing it on a predetermined area of their desk and other furniture.

The form factor and use of mobile technology today gives rise to people seeking to hide it, make it invisible, camouflage it [8] or demonstrate polite use (e.g., placing it face down when with others). However, commodity devices may not be well equipped to support such use as they may require obvious interaction with touch, movement or speech. And while haptic and audio signals may provide subtle outputs, the input required to operate the device may not be subtle. The subtle, inconspicuous and hopefully polite use of technology is what we term Discreet Computing. By supporting face-down interaction, SpeCam may support more inconspicuous forms of interaction.

Take for example the common scenario of people placing their mobile devices face-down to signal their intent to engage socially with those around them. People do this to limit their access to distractions, external entertainment or self-gratification. Maintaining this orientation while supporting interaction isn't readily possible today. SpeCam, as a means to detect surfaces, affords the opportunity to marry the placement or movement of one's mobile device onto different surfaces as a means of interaction. For example, when dining one can consider placing a phone on a table, place mat, menu, or side plate and this might trigger food ordering items. Likewise, placement of the mobile device might trigger audio recording, speech recognition activation, calendar setting in support of the social engagement activity.

By contrast, some people may keep such devices fully hidden from view in a bag or pocket. SpeCam may be employed to measure such surfaces. In this case, we can envisage our technique being used to enable shortcut commands for launching different applications, making phone calls, start a timer, by just placing the phone on different surfaces. Equally we suggest the placement of one's mobile device around the home or office can now afford new forms of smart-environment interaction with SpeCam. The placement of a device may allow people to alter the context of the environment intelligently, including lighting effects and music genres. In the bedroom, side-tables or carpets might trigger the setting of a low light level, alarm and lower volume level of music. While placing ones device on a kitchen surface might trigger the display of particular recipes, set an auto-response on incoming calls and reconfigure the lighting to suit food preparation. The living room can be divided with multiple forms of interaction for multiple people, triggering settings, content filters, auto setup and play for media types and speakers and lighting arrangements.

Mobile devices are often held in pockets, bags or placed face down on surfaces for the sake of politeness. Devices which are in pockets or bags or placed face down may not know their precise location and may not offer context-aware interactions. For example, when receiving a call the time between the call starting and the call going to voice mail may not differ if the phone is currently in one's hand versus hidden away in a pocket. In some circumstances, a phone is face down and someone would like to interact with it, without turning it faceup. The buttons on the side of the device might offer limited functions but the method described above may allow subtle interactions (lifting and replacing) or moving from one surface type to another or being placed on specific surfaces (e.g. a side table vs sofa) to trigger specific types of interactions e.g. playing music, setting a phone to silent, replaying a specific type of out of office message etc.

The sensing of the surface on which the mobile device is currently placed uses the inbuilt screen and camera to achieve surface recognition.

For fast prototyping, our current classification server is implemented on a desktop PC. Our future work will explore a self-contained system where the classification runs on the mobile device itself. Our current results focus on a grounded comparison of a commodity mobile device against the gold standard of a spectrometer, in order to understand the interaction between matter and light. Future work will explore both a wider range of objects and natural face-down scenarios of use.

Our technique also uses a bulky bumper case with about 3 mm of raised lip on the edge, and preferably of black color, for blocking the environmental light from leaking into the camera. We envision that this may be mitigated in the future phones with wider lens and better low light performance.

As the phone display with OLED panel is able to output 16 million colors in the RGB space, a naive approach for improvement may be to explore a wider range of multi-spectral light sources, e.g., a sweep of all the possible colors. However, given that a low-cost smartphone camera may only be able to capture at 30 to 60 frames per second (fps), we must take into account the time required to recognize a surface, as striking a good balance between speed and accuracy is very important. Nonetheless, as our results show, using only 4 to 7 colors already yields very high accuracy.

We describe above a color and material sensing technique for object surfaces using commodity mobile devices. Our implementation is light-weight and uses the device's display and built-in sensors. We report on a two part evaluation of SpeCam which demonstrates that our approach is accurate. We supported the results by comparing them with the results obtain by a dedicated spectrometer. Finally, our applications and use scenarios provide an introduction to what may be possible with SpeCam. Our future work will aim to explore this sensing technique to enable a variety of new interaction capabilities, such as supporting context-aware computing and new forms of discreet computing.

SpeCam is a lightweight surface color and material sensing approach for mobile devices which uses the front-facing camera and the display as a multi-spectral light source. We leverage the natural use of mobile devices (placing it facedown) to detect the material underneath and therefore infer the location or placement of the device. SpeCam can then be used to support discreet micro-interactions to avoid the numerous distractions that users daily face with today's mobile devices. Our two-part study shows that SpeCam can i) recognize colors in the HSB space with 10 degrees apart near the 3 dominant colors and 4 degrees otherwise and ii) 30 types of surface materials with 99% accuracy. These findings are further supported by a spectroscopy study. Finally, we suggest a series of applications based on simple mobile micro-interactions suitable for using the phone when placed face-down.

The system presented above is based on the color detection and reflection properties of the surface on which the phone 10 is placed. Using the phone's display as a light emitter and the camera as a sensor, we do not require additional and custom electronic hardware nor do we disrupt the user experience with audible sound or vibrations.

We leverage the sensors already in mobile devices, so that our technique remains self-contained, ready to be used by millions of off-the-shelf devices, without requiring external electronic modification or adaptation. Fortunately, modern smartphones are equipped with many sensors, such as Inertial Measurement Units (IMU), cameras, microphones etc.

In some embodiments, with these sensors we may achieve various improved sensing capabilities. In line with our objective of achieving color and surface material recognition, we largely employ two built-in components, namely the front-facing camera and the display. We re-purposed the screen display to act as a multi-spectral light source and the front-facing camera as a sensor.

Although in the embodiments described above we focus on leveraging the camera and display, here we also describe how other existing sensors may supplement/complement our technique.
Using the inertial sensor, we know whether a phone has been moved or not. As such, in one embodiment we only trigger the camera for light detection when the phone is significantly moved. We therefore do not need to continually detect the surface underneath the phone, if it has not moved.
Using the orientation sensor and the proximity sensor, we know when the phone is facing down and is near to a surface. Therefore, in some embodiments we can avoid accidentally triggering SpeCam when the device is facing upwards.
In some embodiments, using the magnetometer, we infer whether a nearby surface is metal or non-metal, so that our system is not confused by a layer of metallic coating or paint.

Our technique has been shown to work with surface materials. It may not see inside an object covered by paint or reflective coatings. Using the built-in magnetometer, it may be possible to infer whether a surface is solid metal or it is just covered with metallic paint. Potential solutions may be combining with other types of sensing technique, such as using radar-based systems [22] or Terahertz imaging system [19].

In embodiments described above, the display screen and camera (and optionally the processor) form part of a mobile phone. In other embodiments, the display screen, camera and/or processor may form part of any suitable device or devices. The display screen, camera and processor may be integrated into a single device, or may form part of separate devices. In embodiments image processing and analysis, optionally all processing steps, may be performed in whole or part by the phone or other mobile device itself, for example without use of a separate server or other remote processing device.

In some embodiments, the method and/or apparatus described above may be used in the consumer market. It may be built into any mobile device or Internet of Things device, for example a smartphone, smartwatch, remote controller, clock or mug) so that these devices may be considered to be self-aware and have context-awareness. The devices may know where they are being placed, and trigger actions accordingly. For example, rotating a phone or mug on the kitchen table may adjust a light brightness, which rotating the same phone or mug on the living room sofa may adjust a volume of the TV.

In one embodiment, a user places their phone on the seat of their car. Placing the phone on the car seat causes the phone to automatically switch to the Bluetooth voice system. Moving the phone to the dashboard causes the music player to start.

In one embodiment, placing the phone on the sofa causes music to play. Rotating the phone causes the music player to skip to the next song. Placing the phone on a cushion causes iPlayer to start on the TV while resetting lights and heat levels. The phone may be used to control a wide range of functions without pressing buttons. The phone may be considered to become a controller for a person's life. Clothing and surfaces (for example, at home or at work) may take on a specific context. When the phone is placed there, new interactions may be possible.

In some embodiments, methods described above are used to detect when a user is taking part in a sport, for example running. For example, the classifier may detect that a mobile phone of the user has been placed in a holster on the user's arm. In response to the detection that the mobile phone has been placed in the holster, a mode of operation of the mobile phone may be changed. In some embodiments, the detection that the user is taking part in a sport may also be based on sensor data. For example, data from an accelerometer of the mobile phone may be used to detect movement of the user.

In some embodiments, methods described above are used to allow a user to use their mobile phone as a positional input. The user may use the mobile phone as if it were a mouse or other computational input device. In one embodiment, the user places their mobile phone face down on a surface, and a position of the mobile phone is detected using the classifier. When the user moves their mobile phone across the surface, a further position of the mobile phone is detected using the classifier. The change of position is used to provide a positional input, for example an input to a computer program. In some embodiments, a textured surface may be used to facilitate the use of the mobile phone as if it were a mouse. The textured surface may assist position detection by the classifier. The textured surface may comprise, for example, a grid or checkerboard pattern or colour gradient surface. In some embodiments, inputs from other sensors of the mobile phone may also be used when determining the positional input provided by the mobile phone.

In further embodiments, any combination of data from the camera with sensor data may be used. The sensor data may be used in the classification process. The sensor data may be used in conjunction with a result of classification. For example, the sensor data may be used to decide on an operational mode to use and/or an action to be taken. Sensor data may be obtained from any suitable sensor or combination of sensors. The sensor or sensors may form part of the same mobile device (for example, mobile phone) as the display screen and the camera (or other light source and light sensor). The sensor or sensors may comprise, for example, an accelerometer, a magnetometer, inertial measurement unit, a microphone, an orientation sensor, a proximity sensor. The sensor data may comprise current sensor data and/or historical sensor data, for example an average value of a sensor input over time or a change in a sensor input over time.

We propose a lightweight color and surface material recognition system that uses the built-in sensors on a mobile device (FIG. 1b). We use the smartphone's display as the multi-spectral light source and the front-facing camera to capture the reflected light. We trained a machine learning classifier for the recognition and showed high recognition accuracy. Unlike previous work, our method only leverages the built-in capabilities of off-the-shelves mobile devices and does not require additional or customized electronic hardware. Moreover, we present a detailed study of the detection system for different colors and materials. We finally discuss how the ability to sense the surface material enables a wide variety of interaction capabilities such as subtle and discreet interactions.

In embodiments described above, a display screen of a mobile phone is used as a light source and a front-facing camera of the mobile phone is used as a light sensor. The camera is positioned on the same front surface of the mobile phone as the display screen.

In other embodiments, any suitable light source and light sensor may be used. For example, the light source may comprise any light source of a mobile phone. The light source may be front-facing or back-facing. The light source may comprise an LED flash of a mobile phone. The light source may comprise the light source of the mobile phone that is used as a torch or flashlight. The light source may comprise an infrared light source of the mobile phone, for example an infrared light source that is used as a position sensor or proximity detector. The light detector may comprise any light detector of the mobile phone.

In other embodiments, the light source and light sensor may be integrated in any suitable device or devices, for example any suitable mobile device.

In some embodiments, a mobile phone comprises a front depth sensor and an infrared camera, and the front depth sensor and/or infrared camera is used as a light sensor.

The experiments described above were subsequently extended by a further set of studies. In the further studies, it is still the case that a front-facing camera of a mobile phone is used for sensing and a front display of the mobile phone is used as a multi-spectral light source. A machine learning classifier is trained to recognize different materials.

In the SpeCam system described above with reference to FIG. 8, a mobile phone 10 is connected to a server 20, which in the system of FIG. 8 is a PC. Classification is performed using the server 20. The studies described above with reference to FIGS. 1 to 7 have been extended by the addition of a self-contained mobile implementation. The self-contained mobile implementation runs in real time on an Android smartphone. In the self-contained mobile implementation, classification is performed on the mobile phone 10. A classifier implemented on the mobile phone 10 performs feature extraction, and performs a classification based on the extracted features.

In some embodiments, the SpeCam system may not comprise a server 20. All processing may be performed on the mobile phone 10.

In the description above with relation to FIG. 6, we described how a spectrometer was used to collect data for a plurality of printed colour A4 sheets of 36 different colours.

The follow-up studies include performing a further evaluation with Pantone (Pantone, 2018) color postcards instead of printed colour sheets. The further studies also comprise re-running the spectrometer study with a reflection probe holder (Ocean Optics, 2018). The reflection probe holder is a mechanical fixture for positioning reflection probes. In the present embodiment, the reflection probe holder is an anodized aluminium platform with machined holes. It is sturdy and simple to use. It may be use to position reflection probes at 45° and 90° to machined surfaces. Using a reflection probe keeps the working distance consistent from one sample to the next, and when taking a reference measurement. Using a reflection probe may enable accurate, repeatable assessments to be obtained.

Data for the printed color sheets was re-collected using the spectrometer as described above but with the addition of the reflection probe holder. It was hypothesized that the reflection probe holder may improve the surface area coverage and reduce noise from environment lighting, hence improving the overall recognition result. Indeed, the determined accuracy of recognition increased slightly to 83.93% from 82.12%.

As described above, it was thought that the printed A4 sheets used in the study described above in relation to FIG. 6 may have limited quality. Since the color sheets were printed on A4 paper using a laser printer, it was thought that the default color range of the laser printer might be limited or the calibration of the laser printer may not be precise.

Therefore, a set of Pantone color cards was purchased for further evaluation. Pantone colors are highly accurate, and are often used by designers. The color codes for each color are standardized and can be searched in the online Pantone database (Pantone, 2018).

45 out of the 100 Pantone color cards were selected based on color similarity (for more challenging evaluation). A study was conducted with the spectrometer and with the SpeCam phone-based system. The reflection probe holder was used. The method used for the study of the Pantone color cards was substantially the same as the method described above in relation to the printed color sheets. Data for the Pantone colour cards was collected with the mobile phone. After all data collection was done, the data was moved to a desktop PC for further analysis, including feature extraction and machine learning training and evaluation.

Results were found to be very accurate at 96.44% (spectrometer) and 98.22% (SpeCam).

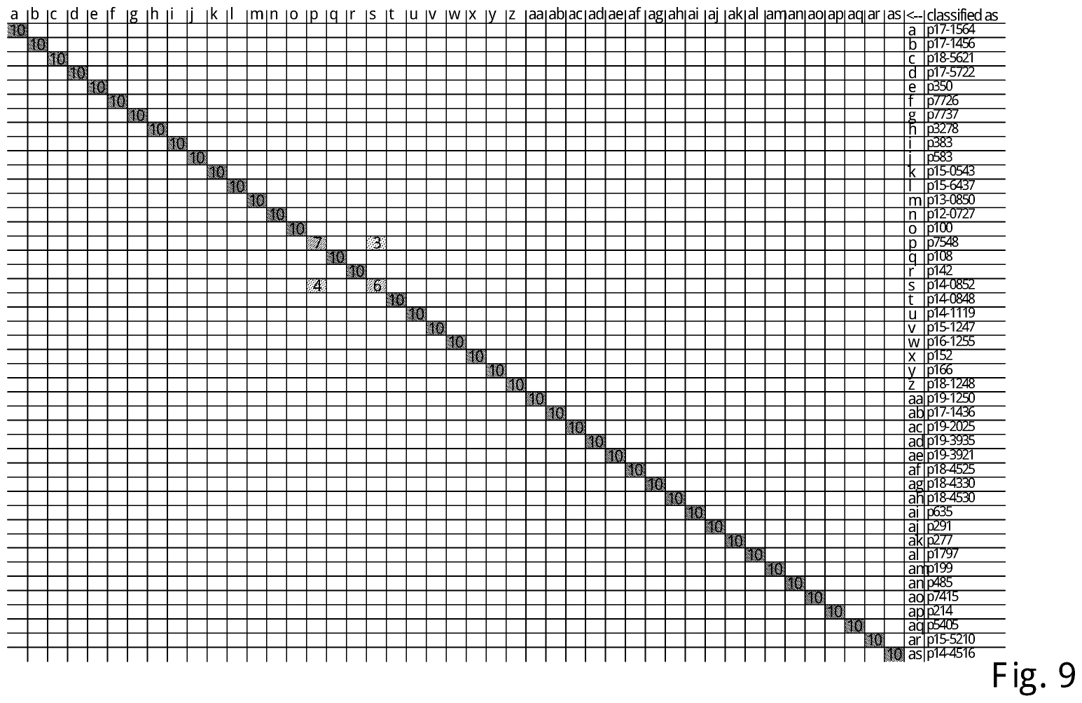

FIG. 9 is a confusion matrix for the Pantone cards study. In the study, Pantone cards were classified using the SpeCam phone-based system, using 7 colors as features. The method was the same as described above with relation to the printed color sheets. Zeros are omitted from the confusion matrix for clarity.

Looking at the confusion matrix of FIG. 9, it may be observed that only two colors were confused with each other by the SpeCam system. The colors that were confused with each other were p7548 and p14-0852.

Visually inspecting the two cards (p7548 and p14-0852) revealed that the two cards are indeed very similar, and it is even difficult to differentiate them with the human eye.

A material classification method was described above with relation to FIGS. 2, 3, 4 and 7. 30 materials were classified using a spectrometer and using the SpeCam system. In the further studies, the material classification was repeated using the spectrometer with the addition of the reflection probe holder. It was found that using the reflection probe holder did not improve the result. The result using the reflection probe holder had an accuracy of 71.38%, which was lower than the accuracy of 78.22% that was achieved without the reflection probe holder.

Further experiments were also performed with different spacing devices used to hold the mobile phone away from the surface. The spacing devices varied in how much ambient light they allowed into a detection region between the mobile phone and the surface. It was found that the presence of light caused worse detection results. However, it may be the case that the machine learning classifier could be retrained to perform detection in the presence of ambient light.

Whilst components of the embodiments described herein have been implemented in software, it will be understood that any such components can be implemented in hardware, for example in the form of ASICs or FPGAs, or in a combination of hardware and software. Similarly, some or all of the hardware components of embodiments described herein may be implemented in software or in a suitable combination of software and hardware.

While certain embodiments have been described, these embodiments have been presented by way of example only, and are not intended to limit the scope of the inventions. Indeed the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms and modifications as would fall within the scope of the invention.

### REFERENCES

1. Rajkumar Darbar and Debasis Samanta. 2015. SurfaceSense: Smartphone Can Recognize Where It Is Kept. In Proceedings of the 7th International Conference on HCI, IndiaHCI 2015 (IndiaHCI'15). ACM, New York, N.Y., USA, 39-46. DOI: http://dx.doi.org/10.1145/2835966.2835971
2. Android Developers. 2017. Android Camera API. (2017). Retrieved Jan. 1, 2017 from https://developer.android.com/reference/android/hardware/Camera.html.
3. Mayank Goel, Eric Whitmire, Alex Mariakakis, T. Scott Saponas, Neel Joshi, Dan Morris, Brian Guenter, Marcel Gavriliu, Gaetano Borriello, and Shwetak N. Patel. 2015. HyperCam: Hyperspectral Imaging for Ubiquitous Computing Applications. In Proceedings of the 2015 ACM International Joint Conference on Pervasive and Ubiquitous Computing (UbiComp '15). ACM, New York, N.Y., USA, 145-156. DOI: http://dx.doi.org/10.1145/2750858.2804282
4. Mark Hall, Eibe Frank, Geoffrey Holmes, Bernhard Pfahringer, Peter Reutemann, and Ian H. Witten. 2009. The WEKA Data Mining Software: An Update. SIGKDD Explor. Newsl. 11, 1 (November 2009), 10-18. DOI: http://dx.doi.org/10.1145/1656274.1656278
5. Chris Harrison and Scott E. Hudson. 2008. Lightweight Material Detection for Placement-aware Mobile Computing. In Proceedings of the 21st Annual ACM Symposium on User Interface Software and Technology (UIST '08). ACM, New York, N.Y., USA, 279-282. DOI: http://dx.doi.org/10.1145/1449715.1449761
6. Tatsuhito Hasegawa, Satoshi Hirahashi, and Makoto Koshino. 2016. Determining a Smartphone's Placement by Material Detection Using Harmonics Produced in Sound Echoes. In Proceedings of the 13th International Conference on Mobile and Ubiquitous Systems: Computing, Networking and Services (MOBIQUITOUS 2016). ACM, New York, N.Y., USA, 246-253. DOI: http://dx.doi.org/10.1145/2994374.2994389
7. Sungjae Hwang and Kwangyun Wohn. 2013. VibroTactor: Low-cost Placement-aware Technique Using Vibration Echoes on Mobile Devices. In Proceedings of the Companion Publication of the 2013 International Conference on Intelligent User Interfaces Companion (IUI '13 Companion). ACM, New York, N.Y., USA, 73-74. DOI:http://dx.doi.org/10.1145/2451176.2451206
8. Matt Jones, Simon Robinson, Jennifer Pearson, Manjiri Joshi, Dani Raju, Charity Chao Mbogo, Sharon Wangari, Anirudha Joshi, Edward Cutrell, and Richard Harper. 2017. Beyond “yesterday's tomorrow”: future-focused mobile interaction design by and for emergent users. Personal and Ubiquitous Computing 21, 1 (2017), 157-171. DOI: http://dx.doi.org/10.1007/s00779-016-0982-0
9. Gierad Laput, Xiang ‘Anthony’ Chen, and Chris Harrison. 2016. SweepSense: Ad Hoc Configuration Sensing Using Reflected Swept-Frequency Ultrasonics. In Proceedings of the 21st International Conference on Intelligent User Interfaces (IUI '16). ACM, New York, N.Y., USA, 332-335. DOI: http://dx.doi.org/10.1145/2856767.2856812
10. Suzanne Low, Yuta Sugiura, Dixon Lo, and Masahiko Inami. 2014. Pressure Detection on Mobile Phone by Camera and Flash. In Proceedings of the 5th Augmented Human International Conference (AH '14). ACM, New York, N.Y., USA, Article 11, 4 pages. DOI: http://dx.doi.org/10.1145/2582051.2582062
11. Consumer Physics. 2017. SCiO: The world's first pocket size molecular sensor. (2017). Retrieved Jan. 1, 2017 from https://www.consumerphysics.com/.
12. A. Quigley, B. Ward, C. Ottrey, D. Cutting, and R. Kummerfeld. 2004. BlueStar, a privacy centric location aware system. In PLANS 2004. Position Location and Navigation Symposium (IEEE Cat. No. 04CH37556). 684-689. DOI:http://dx.doi.org/10.1109/PLANS.2004.1309060
13. Aaron Quigley and David West. 2005. Proximation: Location-Awareness Though Sensed Proximity and GSM Estimation. In Location- and Context-Awareness. Springer Science Business Media, 363-376. DOI: http://dx.doi.org/10.1007/11426646_33
14. Munehiko Sato, Shigeo Yoshida, Alex Olwal, Boxin Shi, Atsushi Hiyama, Tomohiro Tanikawa, Michitaka Hirose, and Ramesh Raskar. 2015. SpecTrans: Versatile Material Classification for Interaction with Textureless, Specular and Transparent Surfaces. In Proceedings of the 33rd Annual ACM Conference on Human Factors in Computing Systems (CHI '15). ACM, New York, N.Y., USA, 2191-2200. DOI: http://dx.doi.org/10.1145/2702123.2702169
15. Alexander Scheeline and Kathleen Kelley. 2017. Cell Phone Spectrophotometer. (2017). Retrieved May 20, 2017 from http://www.asdlib.org/onlineArticles/labware/Scheeline_Kelly_Spectrophotometer/index.html.
16. Yu-Chih Tung and Kang G. Shin. 2015. EchoTag: Accurate Infrastructure-Free Indoor Location Tagging with Smartphones. In Proceedings of the 21st Annual International Conference on Mobile Computing and Networking (MobiCom '15). ACM, New York, N.Y., USA, 525-536. DOI: http://dx.doi.org/10.1145/2789168.2790102
17. Edward Jay Wang, William Li, Doug Hawkins, Terry Gernsheimer, Colette Norby-Slycord, and Shwetak N. Patel. 2016. HemaApp: Noninvasive Blood Screening of Hemoglobin Using Smartphone Cameras. In Proceedings of the 2016 ACM International Joint Conference on Pervasive and Ubiquitous Computing (UbiComp '16). ACM, New York, N.Y., USA, 593-604. DOI: http://dx.doi.org/10.1145/2971648.2971653
18. Jason Wiese, T. Scott Saponas, and A. J. Bernheim Brush. 2013. Phoneprioception: Enabling Mobile Phones to Infer Where They Are Kept. In Proceedings of the SIGCHI Conference on Human Factors in Computing Systems (CHI '13). ACM, New York, N.Y., USA, 2157-2166. DOI: http://dx.doi.org/10.1145/2470654.2481296
19. Karl D. D. Willis and Andrew D. Wilson. 2013. InfraStructs: Fabricating Information Inside Physical Objects for Imaging in the Terahertz Region. ACM Trans. Graph. 32, 4, Article 138 (July 2013), 10 pages. DOI: http://dx.doi.org/10.1145/2461912.2461936
20. Robert Xiao, Scott Hudson, and Chris Harrison. 2016. CapCam: Enabling Rapid, Ad-Hoc, Position-Tracked Interactions Between Devices. In Proceedings of the 2016 ACM on Interactive Surfaces and Spaces (ISS '16). ACM, New York, N.Y., USA, 169-178. DOI: http://dx.doi.org/10.1145/2992154.2992182
21. Xing-Dong Yang, Tovi Grossman, Daniel Wigdor, and George Fitzmaurice. 2012. Magic Finger: Always-available Input Through Finger Instrumentation. In Proceedings of the 25th Annual ACM Symposium on User Interface Software and Technology (UIST '12). ACM, New York, N.Y., USA, 147-156. DOI: http://dx.doi.org/10.1145/2380116.2380137
22. Hui-Shyong Yeo, Gergely Flamich, Patrick Schrempf, David Harris-Birtill, and Aaron Quigley. 2016. RadarCat: Radar Categorization for Input &#38; Interaction. In Proceedings of the 29th Annual Symposium on User Interface Software and Technology (UIST '16). ACM, New York, N.Y., USA, 833-841. DOI: http://dx.doi.org/10.1145/2984511.2984515

1. A method comprising:
positioning a display screen of a mobile device and a surface of interest such that the display screen of the mobile device faces the surface of interest;
emitting light by the display screen, wherein at least part of the emitted light is reflected by the surface of interest;
receiving, by a camera of the mobile device, at least part of the light emitted by the display screen and reflected from the surface of interest thereby to generate at least one image;
and processing the at least one image to determine at least one property of the surface of interest.

2. A method according to claim 1, wherein the positioning of the display screen of the mobile device is such that a distance from the display screen to the surface of interest is less than a focal length of the camera of the mobile device; and
the at least one image comprises at least one unfocused image.

3. A method according to claim 1, wherein the processing of the at least one image comprises extracting at least one feature from the or each image; and
wherein the determining of the at least one property of the surface of interest comprises performing a classification by a machine learning classifier, wherein the classification is based on the extracted at least one feature.

4. A method according to claim 1, wherein the determining of the at least one property of the surface comprises performing a classification of at least one of a material of the surface, a colour of the surface, a texture of the surface.

5. A method according to claim 1, wherein the emitting of the light by the display screen comprises successively emitting light of each of a plurality of different colours of light, and wherein the at least one image comprises a respective image generated for each of the plurality of different colours of light.

6. A method according to claim 1, wherein the processing of the at least one image comprises, for the or each image, determining a respective amplitude for each of the or a plurality of colours.

7. A method according to claim 1, wherein the processing of the at least one image comprises analysing a reflectance spectrum.

8. A method according to claim 1, further comprising distinguishing, by a spectral sensor of the mobile device, different colours of light emitted from the display screen and reflected from the surface of interest; wherein the determining of the at least one property of the surface of interest is in dependence on an output of the spectral sensor.

9. A method according to claim 1, wherein the light emitted by the display screen and received by the camera sensor comprises visible light and at least one of infrared light, ultraviolet light.

10. A method according to claim 1, further comprising determining based on the determined property of the surface of interest a location of the mobile device.

11. A method according to claim 1, wherein positioning the display screen of the mobile device and the surface of interest comprises placing the mobile phone face-down on the surface of interest.

12. A method according to claim 1, the method comprising determining based on the determined property of the surface of interest at least one of:
an operating mode of a computer program;
an operating mode of the mobile device;
an operating mode of a further device;
an input to a computer program;
an input to the mobile device;
an input to a further device;
a command;
a selected one of a set of actions;
a selected one of a set of instructions.

13. A method according to claim 1, the method further comprising receiving data from at least one sensor, wherein the determining of the at least one property of the sensor is in dependence on the data from the at least one sensor.

14. An apparatus comprising:
a mobile device comprising a display screen configured to emit light and a camera configured to receive light emitted from the display screen and reflected from a surface of interest, thereby to generate at least one image; and
a processor configured to process the at least one image to determine at least one property of the surface of interest.

15. An apparatus according to claim 14, wherein the processor forms part of the mobile device.

16. An apparatus according to claim 14, wherein the mobile device comprises at least one of a mobile computing device, a smartphone, a tablet computer, a smartwatch, a wearable computing device.

17. An apparatus according to claim 14, further comprising a spacing device configured to space the display screen apart from the surface of interest.

18. An apparatus according to claim 17, wherein the mobile device comprises a mobile phone, and the spacing device comprises or forms part of a mobile phone case.

19. An apparatus according to claim 17, wherein the spacing device is configured such that, when the spacing device is used to space the display screen apart from the surface of interest, the spacing device at least partially blocks ambient light from a detection region between the display screen and the surface of interest.

20. An apparatus according to claim 14, further comprising a spectral sensor configured to distinguish between different colours of light, wherein the determining of the at least one property of the surface of interest is in dependence on an output of the spectral sensor.

21. A method comprising:
positioning a light source of a mobile device and a surface of interest such that the display screen of the mobile device faces the surface of interest;
emitting light by the light source, wherein at least part of the emitted light is reflected by the surface of interest;
receiving, by the camera of the mobile device, at least part of the light emitted by the display screen and reflected from the surface of interest thereby to generate at least one image;
and processing the at least one image to determine at least one property of the surface of interest.
